(19) United States
(12) Patent Application Publication
(10) Pub. No.: US 2025/0284143 A1
(43) Pub. Date: Sep. 11, 2025

(54) Lens Device with Light Filtering Function of Bionic Lens and Preparation Method Thereof

(71) Applicant: Alis Tech Co., Ltd., Taoyuan City (TW)

(72) Inventors: Ruei-Chuen Chung, Taoyuan City (TW); Chunxu Yang, Belle Mead, NJ (US); Ya-Wen Chung, Taoyuan City (TW)

(73) Assignee: G2 New Visioncare International Inc., Belle Mead, NJ (US)

(21) Appl. No.: 18/794,510

(22) Filed: Aug. 5, 2024

(30) Foreign Application Priority Data
Mar. 8, 2024 (TW) 113108616

(51) Int. Cl. G02C 7/10

(52) U.S. Cl. CPC G02C 7/104; G02C 7/108

(57) ABSTRACT

A lens device with light filtering function of bionic lens and preparation method thereof are disclosed. The lens device includes a lens base material, a plurality of light filtering layers, a plurality of hardened layers, a plurality of light reducing layers and a plurality of waterproof layers; wherein, the plurality of light filtering layers, the plurality of hardened layers, the plurality of light reducing layers and the plurality of waterproof layers are sequentially disposed on both sides of the lens base material. By impregnating the plurality of light filtering layers with a dyeing liquid solution of a specific color, the lens device with the light filtering function of bionic lens is obtained.

### CROSS-REFERENCE TO RELATED APPLICATION

This application claims the benefit of Taiwan Patent Application No. 113108616, filed on Mar. 8, 2024, in the Taiwan Intellectual Property Office, the disclosure of which is incorporated herein in its entirety by reference.

### BACKGROUND OF THE INVENTION

### 1. Field of the Invention

The present invention relates to a lens device with light filtering function of bionic lens and preparation method thereof, more specifically to a lens device capable of simulating the inherent natural light filtering protection and high visual contrast clarity functions of the lens of the human eye, and the preparation method thereof.

### 2. Description of the Related Art

The lens of the human eye has an inherent light filtering protection function which not only completely absorbs UV light, but also filters short-wave violet light and short-wave blue light, and therefore serves as a natural barrier to protect the macula of the retina from light damage. In addition, since short-wave blue light is imaged in front of the retina, filtering short-wave blue light can reduce the chromatic aberration of light, and therefore also provide the visual functions of high contrast clarity to the eyes.

Boettner & Wolter pointed out in a 1962 research report (non-patent literature 1) that the clear lens of 4-year-old children have excellent light transmittance properties and absorb about 30% of 450 nm short-wave blue light; however, as age increases, the tryptophan oxides and protein glycosylated substances in the lens of the human eye gradually increase, causing the transmittance of the lens to decrease and gradually appear slightly yellow. Taking the lens of a 53-year-old adult as an example, the lens can absorb about 60% of 450 nm short-wave blue light, thereby increasing the light-shielding effect of the eyes, thereby improving the protection of the retinal macula (see FIG. 1).

From the perspective of preventing and treating blindness in the population, the World Health Organization (WHO) defines those with cloudy lenses and vision correction less than 0.5 as clinical cataracts, and surgical removal of cloudy lenses is currently the only effective method to treat cataracts; however, after cataract removal, regardless of whether an artificial lens is implanted or not, the natural light filtering protection of the human eye lens disappears, allowing visible short-wave light of 400˜500 nm to directly enter the fundus retina, causing damage to the retinal pigment epithelial cells of the human eye. As a result, the retina is exposed to more of this harmful light, causing an increased incidence of retinal pigment epithelium (RPE) damage or age-related macular degeneration.

In a 10-year epidemiological study, researcher Klein found that the incidence of late-stage age-related macular degeneration in patients after cataract removal was 3.18 times higher than that in patients without cataract surgery; therefore, taking the intraocular lens model AcrySof SN60WF produced by Alcon Inc. as an example, the blue-light filtering intraocular lens with the concept of bionic lens is a new type of artificial lens that has emerged in recent years. Patients implanted with this blue-light filtering intraocular lens have better protection against retinal light damage than those implanted with general ultraviolet absorbing intraocular lenses.

With the advancement of technology, human eyes obtain a large amount of information through reading on mobile phones and computers, and the damage of light to the eyes is increasing day by day. Therefore, the means to reduce the risk of age-related macular degeneration in many patients who undergo cataract surgery with only a non-blue-light filtering intraocular lens implanted is of great interest. Therefore, it is crucial to develop and produce lenses with natural blue-light filtering function of bionic lenses for patients with ordinary artificial lens implants to protect the macula of the retina.

### Non-Patent Literature

1. Boettner, E. A. and Wolter, J. R. (1962) Transmission of the Ocular Media. Investigative Ophthalmology & Visual Science, 1, 776-83.

### SUMMARY OF THE INVENTION

In view of the above-mentioned problems in the conventional art, the objective of the present invention is to provide a lens device with light filtering function of bionic lens and preparation method thereof. The lens device may simulating the lens of a 53-year-old adult which absorbs about 60% of 450 nm short-wave blue light, and therefore increases the light-shielding effect of the eyes and protects the macular part of the retina, avoiding damage to the human eyes caused by blue light emitted by the screen when people of modern age watch mobile phone screens or computer screens for extensive period of time.

To achieve the foregoing objective, the first object of the present invention is to provide a lens device with light filtering function of bionic lens, the lens device comprises a lens base material, a plurality of light filtering layers, a plurality of hardened layers, a plurality of light reducing layers, and a plurality of waterproof layers.

Wherein, the plurality of light filtering layers, the plurality of hardened layers, the plurality of light reducing layers and the plurality of waterproof layers are sequentially disposed on both sides of the lens base material, thereby forming a double-sided light filtering structure. In other words, the lens device uses the lens base material as the main body, and in the order of distancing from both sides of the lens base material, the light filtering layers, the hardened layers, the light reducing layers, and the waterproof layers are sequentially stacked.

The lens base material is not particularly limited. Common resin lens materials can be used as the lens base material, and the lens base material may be a base material for non-powered or powered refractive correction lens.

The light filtering layers exhibit brown-yellow-green color, preferably, the brown-yellow-green color exhibits a color concentration (degree of dyeing) of 28˜32%, at this color concentration, the lens of a 53-year-old adult can be simulated to absorb about 60% of 450 nm short-wave blue light; more preferably, the brown-yellow-green color exhibits a color concentration of 30%.

The hardened layer may protect the light filtering layer so the lens device may be more wear-resistant and scratch-resistant during future use, thereby extending its service life.

The light reducing layer can be used to reduce the reflection on the surface of the lens device and further improve the light transmission clarity of the lens device.

The waterproof layer can effectively increase the waterproof and anti-fouling performance of the lens device, thereby improving its overall appearance and quality.

On the other hand, the second object of the present invention is to provide a method for preparing a lens device with light filtering function of bionic lens, in which the preparation steps are as follows:
Step S1: forming a light filtering layer on a lens base material by sequentially immersing the lens base material in different dyeing liquids;
Step S2: forming a hardened layer on the light filtering layer by solidifying a hardener at high temperature after immersing the lens base material with the light filtering layer formed thereon in a hardener solution;
Step S3: forming a light reducing layer on the hardened layer by depositing a light reducing material using vacuum evaporation method on the lens base material with the hardened layer formed thereon;
Step S4: forming a waterproof layer on the light reducing layer by depositing a waterproof material using vacuum evaporation method on the lens base material with the light reducing layer formed thereon; and
Step S5: obtaining the lens device with light filtering function of bionic lens.

In summary, the lens device with light filtering function of bionic lens of the present invention utilizes dyeing and light absorption technology to simulate the light filtering state of the 53-year-old crystal of the normal human eye, and through heating, color-mixing, dyeing time control and other processing methods to the dye, the filter layer formed after coloring the resin lens presents a light filtering curve that is similar to the natural lens of the human eye, achieving the blue light filtering function of a bionic lens, unlike conventional dyeing technology using traditional methods which only provides better appearance or sun light reduction effects.

The conventional dyeing technology is to mix premixed pigments into resin lenses, and produce prescription lenses by infusion molding. Such method has the advantage of mass production, but will also cause inconsistent light filtering degrees between the middle and the periphery areas of the lens due to the difference in thickness between the areas of the prescription lens. The dyeing and light absorption technology used to prepare the lens device in the present invention is to immerse the lens base material in heated dye, so that the pigment molecules can be dissolved into a shallow layer of a soft and expanding lens material with a coloring depth of about 0.05˜0.12 mm, after the lens is cooled and the molecular gap is reduced, a uniform light filtering layer is formed on the surface of the lens to avoid inconsistency in the degree of filtered light between the middle and the periphery areas of the lens; however, conventional dyeing techniques use several pigments premixed according to a set proportion, and during the dyeing process, chromatic aberration may occur due to the different pigments in the dye heating and coloring the lens material at different speeds and depths, or due to differences in the composition of the lens material batches resulting in spectral differences between pieces of lens.

The technical features of the present invention will be described in detail below with specific embodiments and accompanying drawings, so that those with ordinary knowledge in the art can easily understand the purpose, features and advantages of the present invention.

### BRIEF DESCRIPTION OF THE DRAWINGS

Exemplary embodiments of the present invention will be more fully understood from the following detailed description and the accompanying drawings of various embodiments, which should not, however, be construed as limiting the present invention to the particular embodiments, but only for explanation and illustration purposes.

FIG. 1 is a schematic diagram of the transmittance of natural human lens to short-wave blue light of 450 nm in a 4-year-old child and a 53-year-old adult;

FIG. 2 is a schematic structural diagram of a lens device with light filtering function of bionic lens according to the present invention;

FIG. 3 is a flow chart of the preparation steps of a lens device with light filtering function of bionic lens according to the present invention;

FIG. 4 is a schematic diagram of the lens device with light filtering function of bionic lens according to the present invention. The spectral transmittance is measured by a spectrum analyzer to obtain the absorption spectrum of each wavelength; and

FIG. 5 is a schematic diagram of the spectrum of an LED lamp with a color temperature of 6000 before and after light filtering using the lens device with light filtering function of bionic lens of the present invention.

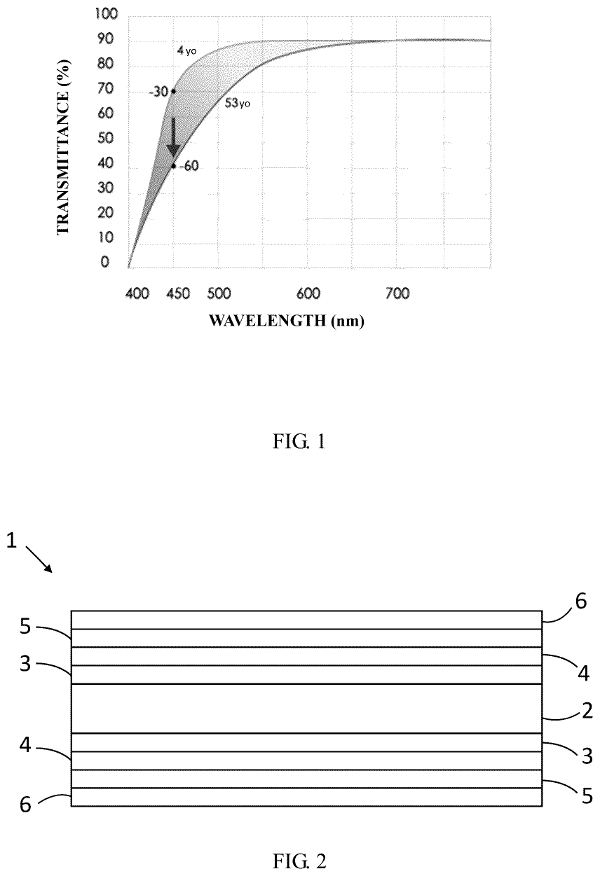

### DETAILED DESCRIPTION OF THE PREFERRED EMBODIMENTS

In order to clearly describe the features, content, advantages and effects of the present invention, the present invention is described in conjunction with the expression form of the accompanying drawings in detail. In addition, the drawings used in the disclosure are only for illustration and assist in understanding the description, and may not represent the actual proportions and precise configurations of the present invention in actual implementation. Therefore, the proportions and arrangement relationships of the attached drawings should not limit the scope of the present invention to practical implementation.

In order to have a more complete and clear disclosure of the technical content, the objective of the invention and the effects achieved by the present invention, reference will be made to the disclosed drawings and numerals for detailed description hereinafter.

All numbers in the present disclosure are understood to be modified by “about”. As used herein, the term “about” is meant to encompass a variation of +10%.

Referring to FIG. 2, which is a schematic structural diagram of a lens device with light filtering function of bionic lens according to the present invention. The lens device 1 includes a lens base material 2, a plurality of light filtering layers 3, a plurality of hardened layers 4, a plurality of light reducing layers 5 and a plurality of waterproof layers 6.

Wherein, the plurality of light filtering layers 3, the plurality of hardened layers 4, the plurality of light reducing layers 5 and the plurality of waterproof layers 6 are sequentially disposed on both sides of the lens base material 2, thereby forming a double-sided light filtering structure. In other words, the lens device 1 uses the lens base material 2 as the main body, and in the order of distancing from both sides of the lens base material 2, the light filtering layers 3, the hardened layers 4, the light reducing layers 5, and the waterproof layers 6 are sequentially stacked.

The lens base material 2 is not particularly limited. Common resin lens materials can be used as the lens base material, and the lens base material 2 may be a base material for non-powered or powered refractive correction lens. For example, the lens base material 2 can be different resin lens materials produced by Shanghai Conant Optics Co., Ltd., such as resin lens materials with different refractive indexes such as CR39 UV++, 1.56 UV++, 1.60 Hi-Vex UV++ or 1.67 UV++, these resin lens materials have at least UV400 anti-ultraviolet function.

The light filtering layers 3 exhibit brown-yellow-green color, preferably, the brown-yellow-green color exhibits a color concentration (degree of dyeing) of 28˜32%, at this color concentration, the lens of a 53-year-old adult can be simulated to absorb about 60% of 450 nm short-wave blue light; more preferably, the brown-yellow-green color exhibits a color concentration of 30%.

The hardened layer 4 may protect the light filtering layer 3 so the lens device 1 may be more wear-resistant and scratch-resistant during future use, thereby extending its service life.

The light reducing layer 5 can be used to reduce the reflection on the surface of the lens device 1 and further improve the light transmission clarity of the lens device 1.

The waterproof layer 6 can effectively increase the waterproof and anti-fouling performance of the lens device 1, thereby improving its overall appearance and quality.

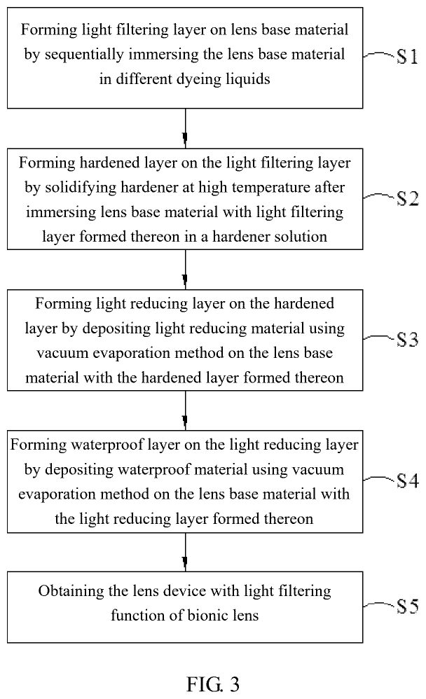

On the other hand, the second object of the present invention is to provide a method for preparing a lens device 1 with light filtering function of bionic lens, in which the preparation steps are as follows (please refer to FIG. 3):

Step S1: forming a light filtering layer 3 on a lens base material 2 by sequentially immersing the lens base material 2 in different dyeing liquids;

In step S1, the dyeing method is a thermal dyeing method which includes the following process: after the lens base material 2 is washed and cleaned, it is immersed in a container with a dyeing solution (purchased from Brain Power Inc. or CERIUM product group). The container automatically adjusts the temperature with a thermostat to maintain the dyeing solution at the required dyeing temperature to dye the lens base material 2 so that the light filtering layers 3 finally appears brown-yellow-green color on the lens base material 2; preferably, the dyeing temperature is 90˜97° C.; wherein different lens base materials have their own suitable dyeing temperatures, and the dyeing order and dyeing time of dyeing solutions of different colors are also different for different lens base materials. For example, when different resin lens materials produced by Shanghai Conant Optics Co., Ltd. are used as the lens base material 2, the corresponding dyeing sequence, dyeing time and dyeing temperature are as shown in Table 1 below:

TABLE 1

| | | | | | | 1.60 Hi-Vex | | | |
|---|---|---|---|---|---|---|---|---|---|
| | lens model | CR39 UV++ | | 1.56 UV++ | | UV++ | | 1.67 UV++ | |
| dyeing | temperature | 93~95° | C. | 90~93° | C. | 93~95° | C. | 95~97° | C. |
| sequence | | | | | | | | | |
| 1 | yellow dyeing liquid | 30~50 | sec | 20~30 | sec | 70~90 | sec | 120~150 | sec |
| 2 | brown dyeing liquid | 8~12 | sec | 5~8 | sec | 20~30 | sec | 30~50 | sec |
| 3 | red dyeing liquid | 1~2 | sec | 2~3 | sec | 5~8 | sec | 10~15 | sec |
| 4 | green dyeing liquid | 3~5 | sec | 2~3 | sec | 3~5 | sec | 8~12 | sec |

Specifically, first the lens base material 2 is immersed in yellow dyeing liquid, dyed at the temperature and time showed in Table 1, taken out, washed in clean hot water to remove excess dyeing liquid, and then immersed in brown dyeing liquid, dyed at the temperature and time showed in Table 1, taken out, and so on by analogy to dye the above four colors in sequence, and finally obtain the light filtering layer 3 showing brown-yellow-green color on the lens base material 2; preferably, the concentration of each dyeing liquid is about 6 to 10% (vol %).

Preferably, after the lens base material 2 is dyed in the above step S1, the formed light filtering layer 3 exhibits a brown-yellow-green color with a color concentration of 28˜32%; more preferably, the light filtering layer 3 exhibits a brown-yellow-green color with a color concentration of 30%.

Step S2: forming a hardened layer 4 on the light filtering layer 3 by solidifying a hardener at high temperature after immersing the lens base material 2 with the light filtering layer 3 formed thereon in a hardener solution;

Step S3: forming a light reducing layer 5 on the hardened layer 4 by depositing a light reducing material using vacuum evaporation method on the lens base material 2 with the hardened layer 4 formed thereon;

Step S4: forming a waterproof layer 6 on the light reducing layer 5 by depositing a waterproof material using vacuum evaporation method on the lens base material 2 with the light reducing layer 5 formed thereon; and

Step S5: obtaining the lens device 1 with light filtering function of bionic lens.

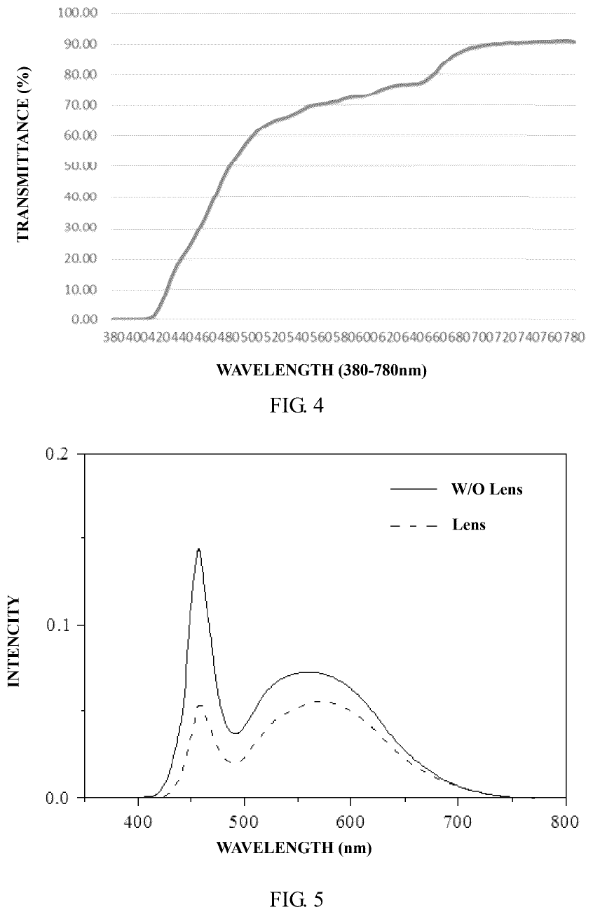

Next, referring to FIG. 4, illustrating a schematic diagram of the lens device with light filtering function of bionic lens according to the present invention. The spectral transmittance is measured by a spectrum analyzer to obtain the absorption spectrum of each wavelength.

In the lens device 1 obtained by the preparation method of the above steps S1 to S5, using the resin lens of model 1.60 Hi-Vex UV++ as the lens base material 2 for example, through the analysis of the spectrometer, as shown in FIG. 4, it can be seen that in the 450 nm short-wave blue light sector, the transmittance is only about 40%, that is, absorbs about 60% of the short-wave blue light. This can confirm that the prepared lens device 1 indeed achieved to simulate the blue light filtering effects of the lens of a 53-year-old adult.

### Experimental Example 1: Retinal Cell Survival Rate Experiment

The lens device 1 was sent to the Retina Cell Laboratory of National Taiwan University Hospital to conduct a 24-hour retinal cell survival rate experiment using 661W mouse retinal photoreceptor cell line; the 661W mouse retinal photoreceptor cells were derived from mouse retinal tumors and contain pigment proteins unique to cone cells such as transducin and arrestin, and are the most commonly used cells that are light-sensitive and easy to culture. At the same time, using such cells for pioneering experiments can greatly reduce the number of animals used in future animal experiments.

The experimental steps for retinal cell survival rate are as follows:
1. Cell culture: Seed 661W cells in a sterile cell culture dish with a diameter of 10 cm, and cultured in a cell culture incubator at 37° C. with a humidified atmosphere containing 5% CO₂; the cell culture medium contains 10% FBS, 100 U/mL penicillin, 100 mg/mL streptomycin in DMEM. Every two or three days, the cells were excised with trypsin and subcultured.

2. Pre-irradiation treatment: After detaching the attached cells with trypsin, the cells were first stained with trypan blue and then counted; then, according to the calculation results, diluted to a cell solution containing 3×10³ cells per 1000 μL. Then, in a 96-well sterile cell culture plate, 100 μL of cell solution was planted in each well, and incubated in a cell culture incubator containing 5% CO₂ at 37° C. for 24 hours. After 24 hours of cell adhering, the culture solution was changed to DMEM containing 1% FBS and conduct lighting experiments under different conditions.

3. Irradiation: Move the 96-well sterile cell culture plate into a cell culture incubator for culture, and divide the cells into a control group and an experimental group; wherein, the control group is a non-illumination group, and its cells do not receive illumination, while the cells in the illumination group are exposed to white light LED (illumination of 800 lux) and color temperature of 5600K for 24 hours. In order for the cells to receive the same light energy, a layer of light-homogenizing film is added to the white LED light source, which can effectively convert the point or linear light source into a soft, uniform surface light source which is evenly diffused. The experimental group placed the lens device 1 on the light-homogenizing film under the petri dish, and each experiment was repeated three times to reduce experimental errors.

4. CCK-8 (Cell Counting kit-8) assay to detect cell survival rate: Seed 3×10³ 661W cells in a 96-microwell plate. After 24 hours of cells adhering, replace the culture medium to DMEM with 1% FBS then subjected to illumination experiments under different conditions; then, after 24 hours of illumination, 10 μL of CCK-8 was added to each microwell and reacted at 37° C. for 2 hours, and finally the absorbance value of the solution at 450 nm was detected with a microplate analyzer (Microplate reader). The cell survival rate is calculated by using the absorbance value of the non-illuminated group as the control absorbance value. Divide the absorbance value of the experimental group by the control absorbance value and then multiply by 100% to obtain the cell survival rate.

5. Statistical analysis: A two-way analysis of variance (ANOVA) was performed to determine whether the lens device 1 can significantly protect retinal photoreceptor cells, wherein a P value <0.05 was considered to have a significant difference. The results are shown as follows in Table 2.

TABLE 2

| | | Cell | | |
|---|---|---|---|---|
| | | survival | Experimental | |
| | Sample | rate | conditions | Remarks |
| Experimental | Bionic blue light | 70.68% | 800 lux white | P < 0.05 |
| group | filtering lens | | light LED, color | |
| Control | W/O Bionic blue | 56.47% | temperature | |
| group | light filtering | | 5600K | |
| | lens | | | |

It can be seen from Table 2 that when the lens device 1 is placed, the cell survival rate is significantly improved, which means that the lens device 1 can indeed improve the survival rate of retinal photoreceptor cells.

### Experimental Example 2: Detection of Photoretinitis Alleviation Effect and Melatonin Suppression/Alleviation Effect

The lens device 1 was sent to the Nano-Organic Optoelectronics Laboratory of Tsinghua University, and an LED lamp with a color temperature of 6000K was used to conduct the photoretinitis alleviation experiment and the melatonin suppression/alleviation experiment. This experiment was performed by placing the lens device 1 at a distance of 18 centimeters from a light source, and the filtered spectrum was measured with a spectrometer (model PR-655) at a distance of 8 centimeters from the other side of the lens device 1 (i.e., the side opposite to the light source), and then conduct illumination measurement by an illuminance meter (model LX-101), and finally obtain the spectrum of the LED lamp before and after light filtering (also referring to FIG. 5). The results are shown in Table 3 below.

TABLE 3

| | Control group | Experimental |
|---|---|---|
| Item | (no lens) | group |
| Illumination (lux) | 1704 | 1035 |
| Illumination difference (%) | −39 | |
| Melatonin suppression sensitivity | 5.2 | 2.8 |
| MSS@460 nm (%) | | |
| Melatonin suppression and | +46 | |
| alleviation effect (%) | | |
| Maximum allowable exposure limit | 313 | 591 |
| MPE@100 lux (sec) | | |
| Photoretinitis alleviation | +89 | |
| effect @ 100 lux (sec) | | |
| Maximum allowable exposure limit | 3132 | 5908 |
| MPE@10 lux (sec) | | |

| | |
|---|---|
| Photoretinitis alleviation | +89 |
| effect @ 10 lux (sec) | |

| | Control group | Experimental |
|---|---|---|
| Spectral influence detection | (no lens) | group |
| Natural spectral similarity | 93 | 92 |
| index SRI (%) | | |

| | |
|---|---|
| SRI difference (%) | −1 |

SRI: surface regularity index, a parameter used to reflect the regularity of the corneal surface within 4.5 mm of the corneal pupil area.

As can be seen from FIG. 5, after being filtered by the lens device 1, the light intensity of each waveband decreases significantly, and it can also be seen from Table 3 above that the photoretinitis alleviation effect and melatonin suppression/alleviation effect is also significantly improved; therefore, these results can further confirm that the lens device 1 has a protective effect on the retina of the eye and the body.

In summary, the lens device with light filtering function of bionic lens of the present invention utilizes dyeing and light absorption technology to simulate the light filtering state of the 53-year-old crystal of the normal human eye, and through heating, color-mixing, dyeing time control and other processing methods to the dye, the filter layer formed after coloring the resin lens presents a light filtering curve that is similar to the natural lens of the human eye, achieving the blue light filtering function of a bionic lens, thus effectively protects people's eyes who undergo cataract surgery with only a non-blue-light filtering intraocular lens implanted from damage caused by looking at mobile phones and computer screens for extensive period of time.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A lens device with light filtering function of bionic lens, comprising:
a lens base material;
a plurality of light filtering layers respectively disposed on both sides of the lens base material;
a plurality of hardened layers respectively disposed on one side of the plurality of light filtering layers facing away from the lens base material;
a plurality of light reducing layers respectively disposed on one side of the plurality of hardened layers facing away from the lens base material; and
a plurality of waterproof layers respectively disposed on one side of the plurality of light reducing layers facing away from the lens base material, wherein
the plurality of light filtering layers exhibit a brown-yellow-green color.

2. The lens device of claim 1, wherein the lens base material is made of a resin material, and the lens base material is a base material for non-powered or powered refractive correction lens.

3. The lens device of claim 1, wherein the plurality of light filtering layers exhibit a brown-yellow-green color with color concentration of 28˜32%.

4. The lens device of claim 1, wherein the lens device is able to absorb about 60% of 450 nm short-wave blue light.

5. The lens device of claim 1, wherein the plurality of light filtering layers are made by dyeing the lens base material using a thermal dyeing method, in which the dyeing temperature is 90˜97° C.

6. The lens device of claim 5, wherein the thermal dyeing method is to sequentially dye the lens base material with yellow dyeing liquid, brown dyeing liquid, red dyeing liquid and green dyeing liquid; and the lens base material is washed in clean hot water between dyeing in different dyeing liquids.

7. A method for preparing a lens device with light filtering function of bionic lens, comprising the following steps:
step S1: forming a light filtering layer on a lens base material by sequentially immersing the lens base material in different dyeing liquids;
step S2: forming a hardened layer on the light filtering layer by solidifying a hardener at high temperature after immersing the lens base material with the light filtering layer formed thereon in a hardener solution;
step S3: forming a light reducing layer on the hardened layer by depositing a light reducing material using vacuum evaporation method on the lens base material with the hardened layer formed thereon;
step S4: forming a waterproof layer on the light reducing layer by depositing a waterproof material using vacuum evaporation method on the lens base material with the light reducing layer formed thereon; and
step S5: obtaining the lens device with light filtering function of bionic lens, wherein the light filtering layer, the hardened layer, the light reducing layer and the waterproof layer are formed on both sides of the lens base material; and
the light filtering layers exhibit brown-yellow-green color.

8. The method of claim 7, wherein the lens device is able to absorb about 60% of 450 nm short-wave blue light.

9. The method of claim 7, wherein in step S1, the light filtering layer is made by dyeing the lens base material using a thermal dyeing method, in which the dyeing temperature is 90˜97° C.

10. The method of claim 9, wherein the thermal dyeing method is to sequentially dye the lens base material with yellow dyeing liquid, brown dyeing liquid, red dyeing liquid and green dyeing liquid; and the lens base material is washed in clean hot water between dyeing in different dyeing liquids.
